(19) United States
(12) Patent Application Publication
(10) Pub. No.: US 2026/0348480 A1
(43) Pub. Date: Nov. 5, 2026

(54) Flow rate adjusting device

(71) Applicant: Surpass Industry Co., Ltd., Gyoda-shi (JP)

(72) Inventor: Atsushi INOUE, Gyoda-shi (JP)

(21) Appl. No.: 19/666,660

(22) Filed: May 4, 2026

(30) Foreign Application Priority Data
May 2, 2025 (JP) 2025-076796

(51) Int. Cl. F16K 7/16; F16K 27/02

(52) U.S. Cl. CPC F16K 7/16; F16K 27/0236; F16K 2200/30

(57) ABSTRACT

A flow rate adjusting device includes an opening/closing mechanism configured to contact or move from a valve seat to establish a closed or open state; a biasing force generating unit configured to generate a biasing force that moves the opening/closing mechanism to contact the valve seat; a diaphragm connected to the opening/closing mechanism and arranged to partition the pressure chamber and the valve chamber; and a connection part configured to connect the opening/closing mechanism and the diaphragm. The opening/closing mechanism has a valve body and shaft part connected to the valve body, the diaphragm has a base part having a through hole and a thin-film part formed annularly about the axis so as to be connected to the outer circumferential edge of the base part, and the connection part connects the shaft part, which is inserted in the through hole and protrudes into the pressure chamber, to the base part.

### CROSS-REFERENCE TO RELATED APPLICATIONS

This application claims foreign priority benefits under U.S.C. §119 to Japanese Patent Application No. 2025-076796 filed on May 2, 2025, the contents of which is hereby incorporated by reference in its entirety.

### BACKGROUND

### 1. TECHNICAL FIELD

The present disclosure relates to a flow rate adjusting device.

### 2. DESCRIPTION OF RELATED ART

Flow rate adjusting devices including a flow rate adjusting unit configured to adjust the flow rate of a liquid such as a chemical agent or pure water used for semiconductor manufacturing devices are conventionally known (for example, Japanese Patent No. 6093206, hereafter referred to as PTL1).

The flow rate adjusting device disclosed in PTL1 pressurizes a pressure chamber to push a diaphragm downward, thereby causes the valve body arranged in the valve chamber to be spaced apart from a valve seat, and allows a fluid to flow from an upstream first space into a downstream second space. The fluid that has flowed into the first space from the inlet port flows into the second space and flows out of the outlet port.

The flow rate adjusting device disclosed in PTL1 is formed such that a protrusion formed to an axially formed end of the valve body is connected by clearance fit to a concave part formed in a base part of a diaphragm partitioning the pressure chamber and the valve chamber from each other. By connecting the diaphragm to the valve body, it is possible to move the valve body in conjunction with motion of the diaphragm subjected to the pressure of the pressure chamber.

In the flow rate adjusting device disclosed in PTL1, however, since the connection portion connecting the diaphragm and the valve body to each other is on the valve chamber side, particles present in the connection portion may flow into a liquid. Herein, the term of particles refers to, for example, particles of a raw material generated during manufacturing or fine particles of a raw material or the like peeled off by friction or the like occurring at the connection portion during operation of the flow rate adjusting device.

The present disclosure has been made in view of such circumstances and intends to provide a flow rate adjusting device that can suppress a malfunction that particles flow into a liquid flowing in from an inlet port and discharged from an outlet port.

### SUMMARY

The present disclosure employs the following solutions in order to achieve the object described above.

A flow rate adjusting device according to one aspect of the present disclosure includes: a first housing having a pressure chamber formed inside the first housing, in which an operating gas is externally introduced into the pressure chamber; a second housing having a valve chamber, an upstream channel, and a downstream channel that are formed inside the second housing, the upstream channel allowing the valve chamber and an inlet port to communicate with each other, and the downstream channel allowing the valve chamber and an outlet port to communicate with each other; an opening/closing mechanism configured to come into contact with or move away from a valve seat provided on an inner circumferential face of the valve chamber to establish a closed state where the upstream channel and the downstream channel are blocked from each other or an open state where the upstream channel and the downstream channel are in communication with each other; a biasing force generating unit configured to generate a biasing force that moves the opening/closing mechanism in a direction of coming into contact with the valve seat; a first diaphragm connected to the opening/closing mechanism to move along an axis and arranged between the first housing and the second housing so as to partition the pressure chamber and the valve chamber from each other; and a connection part configured to connect the opening/closing mechanism and the first diaphragm to each other. The opening/closing mechanism has a valve body accommodated in the valve chamber and configured to come into contact with or move away from the valve seat, and a shaft part connected to the valve body and axially formed extending along the axis. The first diaphragm has a base part formed circularly about the axis and having a through hole at the center of the base part, and a first thin-film part formed annularly about the axis so as to be connected to an outer circumferential edge of the base part and having a smaller thickness along the axis than the base part. The connection part connects the shaft part to the base part inside the pressure chamber, the shaft part being inserted in the through hole and protruding into the pressure chamber.

According to the flow rate adjusting device of one aspect of the present disclosure, the first diaphragm, which partitions the pressure chamber to which an operating gas is introduced and the valve chamber from each other, and the opening/closing mechanism are connected by the connection part. Thus, when the pressure chamber is pressurized, the open state where the upstream channel and the downstream channel are in communication with each other is obtained, and when the pressure chamber is depressurized, the closed state where the upstream channel and the downstream channel are blocked from each other is obtained.

The opening/closing mechanism has a valve body and a shaft part connected to the valve body, and the shaft part is inserted in the through hole formed in the base part of the first diaphragm. The shaft part protruding into the pressure chamber is connected to the base part of the first diaphragm by the connection part inside the pressure chamber. Since the connection portion where the first diaphragm and the shaft part of the opening/closing mechanism are connected to each other is arranged inside the pressure chamber, no liquid flows into this connection portion, and no particle is mixed into a liquid that has flowed in. It is therefore possible to suppress a malfunction that particles flow into a liquid flowing in from the inlet port and discharged from the outlet port.

In the flow rate adjusting device according to one aspect of the present disclosure, a configuration may be employed in which the valve chamber has a first space being in communication with the upstream channel, the valve body being arranged in the first space, and a second space being in communication with the downstream channel, the shaft part being arranged in the second space, and a valve hole is formed in the second housing, the valve hole allowing the first space and the second space to communicate with each other, and the opening/closing mechanism being inserted in the valve hole, the opening/closing mechanism has a second thin-film part formed annularly about the axis so as to be connected to an outer circumferential edge of the valve body and has a second diaphragm partitioning the valve chamber and a lower space from each other, the biasing force generating unit being arranged in the lower space, a second outer diameter of the second thin-film part is smaller than a first outer diameter of the first thin-film part, and an amount of movement along the axis of the opening/closing mechanism from the open state to the closed state is set to be 10% or less of the second outer diameter.

According to the flow rate adjusting device of the present configuration, since the second outer diameter of the second diaphragm is smaller than the first outer diameter of the first diaphragm, the second thin-film part is more deformed than the first thin-film part by opening and closing operation of the opening/closing mechanism and is more likely to be fractured. Accordingly, by setting the amount of movement along the axis of the opening/closing mechanism from the open state to the closed state to be 10% or less of the second outer diameter, it is possible to reduce deformation of the second thin-film part against the opening and closing operation of the opening/closing mechanism to suppress a malfunction that the second thin-film part finally fractures. Further, reduced deformation of the second thin-film part against the opening and closing operation of the opening/closing mechanism can prevent a malfunction that particles are mixed into the liquid due to generation of dust from the second thin-film part.

In the flow rate adjusting device of the above configuration, a form is preferably employed in which the valve body, the shaft part, and the second diaphragm are integrally formed of PFA.

According to the flow rate adjusting device of the present form, the valve body, the shaft part, and the second diaphragm are integrally formed of PFA. The integrally formed member is formed by melting PFA, for example. Therefore, for example, it is possible to suppress a malfunction that particles are mixed into a liquid compared to a case where the member is formed by a production method of compacting a powdered resin material (PTFE or the like).

In the flow rate adjusting device according to one aspect of the present disclosure, a configuration may be employed in which a seal protrusion is formed on an end face on the valve chamber side of the base part, the seal protrusion being formed about the axis so as to surround the through hole and protruding to the valve chamber, a seal groove and an external thread are formed to the shaft part, the seal groove being formed annularly about the axis so as to be engaged with the seal protrusion, and the external thread being formed in a region protruding to the pressure chamber in a state where the shaft part is inserted in the through hole, the connection part is a member having a fastening hole having an internal thread formed in an inner circumferential face of the fastening hole, the opening/closing mechanism is connected to the first diaphragm by the internal thread of the connection part being fastened onto the external thread of the shaft part, and in a state where the opening/closing mechanism and the first diaphragm are connected by the connection part, the seal protrusion comes into contact with the seal groove, and a seal region extending about the axis is formed.

According to the flow rate adjusting device of the present configuration, the internal thread of the connection part is fastened onto the external thread of the shaft part, and thereby the opening/closing mechanism is connected to the first diaphragm. In a state where the opening/closing mechanism and the first diaphragm are connected by the connection part, the seal protrusion comes into contact with the seal groove, and the seal region extending about the axis is formed. Accordingly, by forming the seal region, it is possible to firmly tighten and connect the opening/closing mechanism and the first diaphragm to each other while preventing a liquid from flowing from the valve chamber into the pressure chamber.

In the flow rate adjusting device according to one aspect of the present disclosure, a configuration may be employed in which the first diaphragm and the opening/closing mechanism are formed of a resin material, and the connection part is a weld part, in which a region of the shaft part inserted in the through hole and protruding into the pressure chamber and a region surrounding the through hole of the base part are welded at the weld part by a welding material that is a resin material.

According to the flow rate adjusting device of the present configuration, a region of the shaft part inserted in the through hole and protruding into the pressure chamber and the region surrounding the through hole of the base part are welded by a welding material that is a resin material, and thereby the opening/closing mechanism and the first diaphragm can be reliably connected to each other. Further, because the through hole is surrounded by the weld part, it is possible to prevent a liquid from flowing from the valve chamber into the pressure chamber.

In the flow rate adjusting device of the above configuration, a form may be employed in which a step part is formed to the shaft part, the step part having an outer diameter increasing toward a distal end and being arranged at an end of the through hole in a state where the shaft part is protruded into the pressure chamber.

According to the flow rate adjusting device of the present form, the shaft part having the step part formed thereto is driven into the through hole formed in the base part of the first diaphragm, and thereby a state where the elastically deformed step part is arranged at the end of the through hole can be obtained. Since the step part is engaged with the end of the through hole and thereby the shaft part is positioned with respect to the base part of the first diaphragm, operation to form the weld part can be easily performed by using a welding material.

In the flow rate adjusting device of the above configuration, a form may be employed in which a seal groove is formed on an end face on the valve chamber side of the base part so as to surround the through hole, an annular seal protrusion protruding toward the end face of the base part along the axis so as to be engaged with the seal groove is formed in the shaft part, and in a state where the opening/closing mechanism and the first diaphragm are connected by the connection part, the seal protrusion comes into contact with the seal groove, and a seal region extending about the axis is formed.

According to the flow rate adjusting device of the present form, in a state where the opening/closing mechanism and the first diaphragm are connected by the weld part, the seal protrusion comes into contact with the seal groove, and the seal region extending about the axis is formed. Thus, by forming the seal region, it is possible to firmly connect the opening/closing mechanism and the first diaphragm to each other while preventing a liquid from flowing from the valve chamber into the pressure chamber.

According to the present disclosure, a flow rate adjusting device that can suppress a malfunction that particles flow into a liquid flowing in from an inlet port and discharged from an outlet port can be provided.

### BRIEF DESCRIPTION OF THE DRAWINGS

FIG. 1 is a longitudinal sectional view illustrating a full-closed state of a flow rate adjusting device of a first embodiment of the present disclosure.

FIG. 2 is a longitudinal sectional view illustrating a full-open state of the flow rate adjusting device of the first embodiment of the present disclosure.

FIG. 3 is a partial enlarged view of a part A illustrated in FIG. 1.

FIG. 4 is a longitudinal sectional view illustrating a full-closed state of a flow rate adjusting device of a second embodiment of the present disclosure.

FIG. 5 is a partial enlarged view of a part near a weld part illustrated in FIG. 4.

### DETAILED DESCRIPTION

### First Embodiment

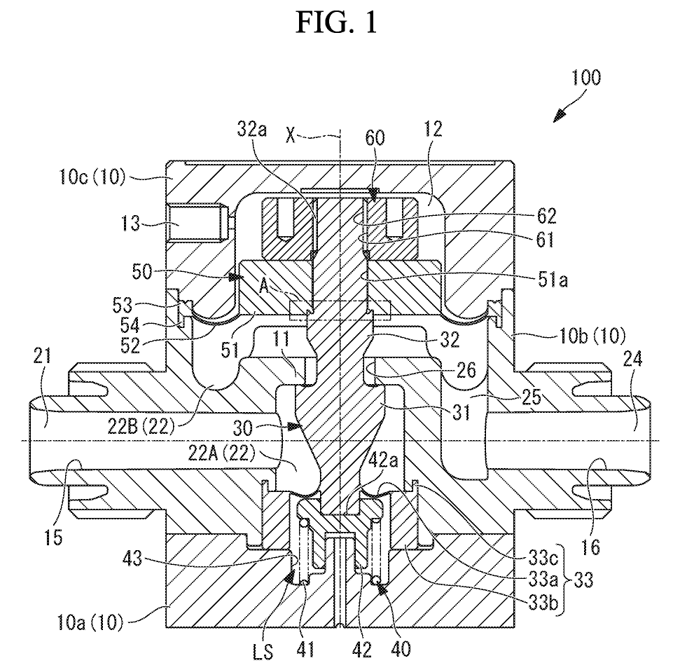

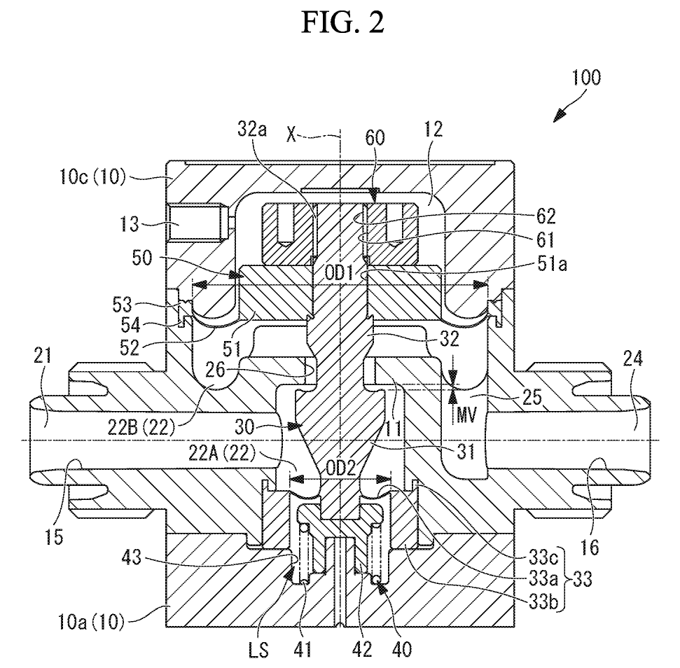

A flow rate adjusting device 100 according to a first embodiment of the present disclosure will be described below with reference to the drawings. FIG. 1 is a longitudinal sectional view illustrating a full-closed state of the flow rate adjusting device 100 of the present embodiment. FIG. 2 is a longitudinal sectional view illustrating a full-open state of the flow rate adjusting device 100 of the present embodiment.

The flow rate adjusting device 100 illustrated in FIG. 1 and FIG. 2 is used for adjusting the flow rate of a liquid such as a chemical agent or pure water used for manufacturing semiconductors or the like and provided on a liquid supply line (not illustrated), and such a flow rate adjusting device is referred to as a regulator in general.

The flow rate adjusting device 100 includes a housing unit 10, an opening/closing mechanism 30, a biasing force generating unit 40, a diaphragm (first diaphragm) 50, and a connection part 60. The opening/closing mechanism 30 has a valve body 31, a shaft part 32, and a diaphragm (second diaphragm) 33.

The housing unit 10 forming the external shape of the flow rate adjusting device 100 has three housings 10a, 10b, and 10c, which are fastened by using through-bolts (not illustrated). The housing 10b is formed of a fluororesin having excellent chemical resistance, such as tetrafluoroethylene-perfluoroalkyl vinyl ether copolymer (PFA), for example. The housings 10a and 10c are formed of a resin material such as PFA or polyvinyl chloride (PVC), for example.

The housing 10a is a foundation portion of the flow rate adjusting device 100 and fixed by fastening bolts to a casing (not illustrated) in which the flow rate adjusting device 100 is installed. An inlet port 21, an outlet port 24, a valve chamber 22, an upstream channel 15, a downstream channel 16, an intermediate channel 25, and a valve hole 26 are formed inside the housing 10b (second housing).

The valve chamber 22 has a first space 22A which is in communication with the upstream channel 15 and in which the valve body 31 is arranged and a second space 22B which is in communication with the downstream channel 16 and in which the shaft part 32 is arranged. The upstream channel 15 is a channel that allows the first space 22A of the valve chamber 22 and the inlet port 21 to communicate with each other. The downstream channel 16 is a channel that allows the second space 22B of the valve chamber 22 and the outlet port 24 to communicate via an intermediate channel 25.

A liquid that has flowed in from the inlet port 21 passes through the upstream channel 15 and flows into the first space 22A. The liquid that has flowed into the first space 22A flows into the second space 22B via the valve hole 26 from the clearance between the outer circumferential face of the valve body 31 and the valve seat 11. The liquid that has flowed into the second space 22B flows out of the outlet port 24 via the downstream channel 16 from an intermediate channel 25. The valve hole 26 allows the first space 22A and the second space 22B to communicate with each other, and the shaft part 32 of the opening/closing mechanism 30 is inserted therein.

The housing (first housing) 10c has an external shape that is cylindrical about an axis X as the central axis. The axis X is located at the center of the pressure chamber 12 and also located at the centers of the first space 22A and the second space 22B. The pressure chamber 12 into which operating air (operating gas) is externally introduced via an introduction port 13 from an external air pressure supply source (not illustrated) is formed inside the housing 10c.

The opening/closing mechanism 30 is a mechanism configured to come into contact with or move away from the valve seat 11 provided on the inner circumferential face of the valve chamber 22 to establish a closed state where the upstream channel 15 and the downstream channel 16 are blocked from each other or an open state where the upstream channel 15 and the downstream channel 16 are in communication with each other. The opening/closing mechanism 30 has a valve body 31, a shaft part 32, and a diaphragm 33. It is preferable that the valve body 31, the shaft part 32, and the diaphragm 33 be integrally formed of PFA, for example.

The valve body 31 is a member accommodated in the first space 22A of the valve chamber 22 and configured to come into contact with or move away from the valve seat 11 to perform switching between the closed state and the open state.
The shaft part 32 is a member connected to the valve body 31 and axially formed extending along the axis X.

The diaphragm 33 is a member partitioning the valve chamber 22 from a lower space LS in which the biasing force generating unit 40 is arranged. The diaphragm 33 has a thin-film part (second thin-film part) 33a, an outer circumferential end 33b, and an annular convex part 33c. The thin-film part 33a is formed annularly about the axis X so as to be connected to the outer circumferential edge of the valve body 31. The outer circumferential end 33b is connected to the outer circumferential edge of the thin-film part 33a and is thicker than the thin-film part 33a. The annular convex part 33c is provided on the top face of the outer circumferential end 33b and has an upward protruding shape.

The outer diameter of the diaphragm 33 is substantially the same as the inner diameter of a diaphragm insertion groove formed in the housing 10b. When the diaphragm 33 is inserted and accommodated in the diaphragm insertion groove from below the housing 10b, the annular convex part 33c provided to the diaphragm 33 is fitted to an annular concave part provided in the outer circumferential end on the top face of the diaphragm insertion groove.

The biasing force generating unit 40 is a mechanism configured to generate a biasing force that moves the valve body 31 of the opening/closing mechanism 30 in a direction of coming into contact with the valve seat 11. The biasing force generating unit 40 has a spring 41 and a spring holder 42. A concave part 42a recessed downward is formed at substantially the center on the top face side of the spring holder 42, and the lower end of the valve body 31 is inserted therein.

A level-difference part is provided to the spring holder 42 in the middle of the side wall. The side wall below the level-difference part has a smaller outer diameter than the side wall above the level-difference part. The spring 41 is provided to the outer circumference of the spring holder 42 below the level-difference part. A cylindrical valve body restraint hole 43 is formed at substantially the center position of the housing 10a. The valve body restraint hole 43 holds the spring 41 between the spring holder 42 and the valve body restraint hole 43.

The spring 41 is accommodated in the valve body restraint hole 43 of the housing 10a, the lower end of the spring holder 42 to which the diaphragm 33 is connected is inserted in the spring 41, and thereby the spring 41 and the valve body 31 are connected to each other. A biasing force in a direction in which the valve body 31 comes into contact with the valve seat 11 is applied to the valve body 31, which is connected to the spring 41, by an elastic force in a direction in which the spring 41 expands.

The diaphragm 50 is a member connected to the opening/closing mechanism 30 to move along the axis X and arranged between the housing 10c and the housing 10b so as to partition the pressure chamber 12 and the valve chamber 22 from each other. The diaphragm 50 has a base part 51, a thin-film part (first thin-film part) 52, an outer circumferential end 53, and an annular convex part 54.

The base part 51 is formed circularly about the axis X and has a through hole 51a at the center thereof.

The thin-film part 52 is a member formed annularly about the axis X so as to be connected to the outer circumferential edge of the face on the valve chamber 22 side of the base part 51. The thin-film part 52 is thinner than the base part 51 in the thickness along the axis X and is flexibly deformed when the base part 51 is moved along the axis X.

The outer circumferential end 53 is connected to the outer circumferential edge of the thin-film part 52 and is thicker than the thin-film part 52. The annular convex part 54 is provided to the bottom face of the outer circumferential end 53 and has a downward protruding shape. The outer diameter of the diaphragm 50 is substantially the same as the inner diameter of the diaphragm insertion groove formed in the housing 10b. When the diaphragm 50 is inserted and accommodated in the diaphragm insertion groove from above the housing 10b, the annular convex part 54 provided to the diaphragm 50 is fitted to an annular concave part provided in the outer circumferential end on the top face of the diaphragm insertion groove.

The connection part 60 is a member that connects the shaft part 32 of the opening/closing mechanism 30 and the diaphragm 50 to each other. The connection part 60 connects the shaft part 32, which is inserted in the through hole 51a of the base part 51 and protrudes into the pressure chamber 12, to the base part 51 in the pressure chamber 12. The connection part 60 is a member having a fastening hole 61 where an internal thread 62 is formed in the inner circumferential face thereof. It is preferable that the connection part 60 be formed of polyether ether ketone (PEEK).

An external thread 32a is formed on the outer circumferential face of the upper end region of the shaft part 32. The external thread 32a is formed in a region protruding to the pressure chamber 12 in a state where the shaft part 32 is inserted in the through hole 51a. The internal thread 62 of the connection part 60 is fastened onto the external thread 32a of the shaft part 32, and thereby the opening/closing mechanism 30 is connected to the diaphragm 50. The diaphragm 50 is sandwiched between the bottom face of the connection part 60 and the seal groove 32b of the shaft part 32 and thereby connected to the opening/closing mechanism 30.

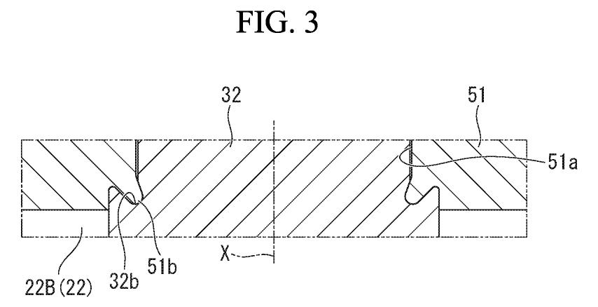

Herein, the seal groove 32b formed in the shaft part 32 and the seal protrusion 51b formed to the base part 51 will be described. FIG. 3 is a partial enlarged view of the part A illustrated in FIG. 1. As illustrated in FIG. 3, the seal protrusion 51b formed about the axis X so as to surround the through hole 51a and protruding toward the valve chamber 22 is formed on the end face on the valve chamber 22 side of the base part 51.

The seal groove 32b formed annularly about the axis X so as to be engaged with the seal protrusion 51b is formed in the shaft part 32. In a state where the opening/closing mechanism 30 and the diaphragm 50 are connected by the connection part 60, the seal protrusion 51b comes into contact with the seal groove 32b, and a seal region extending about the axis X is formed.

The operator assembling the flow rate adjusting device 100 inserts the shaft part 32 into the through hole 51a of the base part 51 and fastens the internal thread 62 of the connection part 60 onto the external thread 32a of the shaft part 32 protruding from the through hole 51a. When the connection part 60 is further rotated about the axis X in a state where the bottom face of the connection part 60 is in contact with the top face of the base part 51, the seal protrusion 51b comes into contact with the seal groove 32b and is partially deformed, and a seal region extending about the axis X is formed.

Herein, an amount of movement MV along the axis X of the opening/closing mechanism 30 from the open state to the closed state will be described. As illustrated in FIG. 2, the outer diameter (second outer diameter) OD2 of the thin-film part 33a of the diaphragm 33 is smaller than the outer diameter (first outer diameter) OD1 of the thin-film part 52 of the diaphragm 50. Thus, the thin-film part 33a is more deformed than the thin-film part 52 by opening and closing operation of the opening/closing mechanism 30 and is more likely to fracture. Accordingly, to suppress a malfunction that the thin-film part 33a finally fractures, it is preferable to set the amount of movement MV along the axis X of the opening/closing mechanism 30 from the open state to the closed state to be 10% or less of the outer diameter OD2.

The effects and advantages achieved by the flow rate adjusting device 100 of the present embodiment described above will be described.

According to the flow rate adjusting device 100 of the present embodiment, the diaphragm 50, which partitions the pressure chamber 12 to which an operating gas is introduced and the valve chamber 22 from each other, and the opening/closing mechanism 30 are connected by the connection part 60. Thus, when the pressure chamber 12 is pressurized, the open state where the upstream channel 15 and the downstream channel 16 are in communication with each other is obtained, and when the pressure chamber 12 is depressurized, the closed state where the upstream channel 15 and the downstream channel 16 are blocked from each other is obtained.

The opening/closing mechanism 30 has the valve body 31 and the shaft part 32 connected to the valve body 31, and the shaft part 32 is inserted in the through hole 51a formed in the base part 51 of the diaphragm 50. The shaft part 32 protruding into the pressure chamber 12 is connected to the base part 51 of the diaphragm 50 by the connection part 60 inside the pressure chamber 12. Since the connection portion where the diaphragm 50 and the shaft part 32 of the opening/closing mechanism 30 are connected to each other is arranged inside the pressure chamber 12, no liquid flows into this connection portion, and no particle is mixed into a liquid that has flowed in. It is therefore possible to suppress a malfunction that particles flow into a liquid flowing in from the inlet port 21 and discharged from the outlet port 24.

According to the flow rate adjusting device 100 of the present embodiment, since the outer diameter OD2 of the diaphragm 33 is smaller than the outer diameter OD1 of the diaphragm 50, the thin-film part 33a is more deformed than the thin-film part 52 by opening and closing operation of the opening/closing mechanism 30 and is more likely to be fractured. Accordingly, by setting the amount of movement MV along the axis X of the opening/closing mechanism from the open state to the closed state to be 10% or less of OD2, it is possible to reduce deformation of the thin-film part 33a against the opening and closing operation of the opening/closing mechanism 30 to suppress a malfunction that the thin-film part 33a finally fractures. Further, reduced deformation of the thin-film part 33a against the opening and closing operation of the opening/closing mechanism 30 can prevent a malfunction that particles are mixed into the liquid due to generation of dust from the thin-film part 33a.

According to the flow rate adjusting device 100 of the present embodiment, the valve body 31, the shaft part 32, and the diaphragm 33 are integrally formed of PFA. The integrally formed member is formed by melting PFA, for example. Therefore, for example, it is possible to suppress a malfunction that particles are mixed into a liquid compared to a case where the member is formed by a production method of compacting a powdered resin material (PTFE or the like). Further, since the mechanical strength of the shaft part 32 is high, a state where the seal groove 32b and the seal protrusion 51b are in contact with each other can be reliably held, and the seal region formed thereby can be maintained.

According to the flow rate adjusting device 100 of the present embodiment, the internal thread 62 of the connection part 60 is fastened onto the external thread 32a of the shaft part 32, and thereby the opening/closing mechanism 30 is connected to the diaphragm 50. In a state where the opening/closing mechanism 30 and the diaphragm 50 are connected by the connection part 60, the seal protrusion 51b comes into contact with the seal groove 32b, and thereby the seal region extending about the axis X is formed. Accordingly, by forming the seal region, it is possible to firmly tighten and connect the opening/closing mechanism 30 and the diaphragm 50 to each other while preventing a liquid from flowing from the valve chamber 22 into the pressure chamber 12.

### Second Embodiment

Next, a flow rate adjusting device 100A according to the second embodiment of the present disclosure will be described with reference to the drawings. The present embodiment is a modified example from the first embodiment and, unless otherwise specified below, is substantially the same as the first embodiment, and some description will be omitted below.

In the flow rate adjusting device 100 of the first embodiment, the opening/closing mechanism 30 and the diaphragm 50 are connected by the connection part 60 having the fastening hole 61 in which the internal thread 62 to be fastened onto the external thread 32a formed to the shaft part 32 is formed in the inner circumferential face of the fastening hole 61. In contrast, the flow rate adjusting device 100A of the present embodiment includes a weld part (connection part) 60A that connects the opening/closing mechanism 30 and the diaphragm 50 by a welding material that is a resin material.

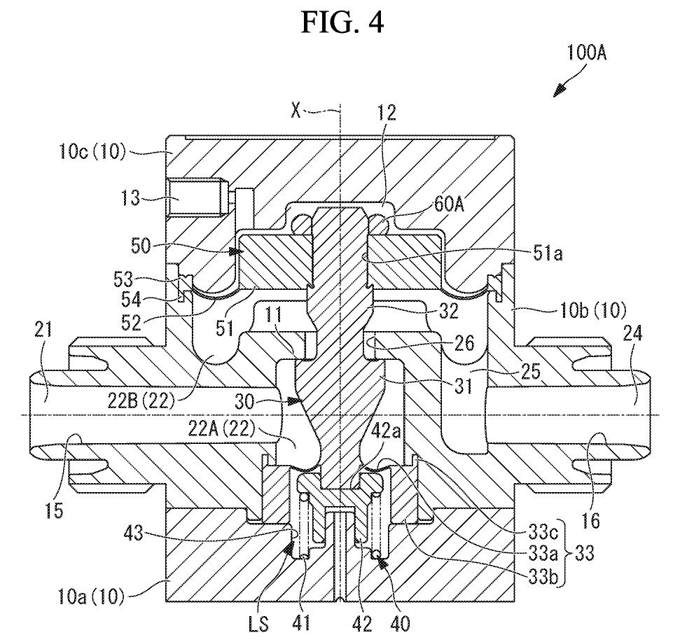

FIG. 4 is a longitudinal sectional view illustrating a full-closed state of the flow rate adjusting device 100A of the second embodiment of the present disclosure. As illustrated in FIG. 4, the flow rate adjusting device 100A includes the weld part 60A. In the flow rate adjusting device 100A of the present embodiment, the diaphragm 50 and the opening/closing mechanism 30 are formed of a resin material such as PFA, respectively.

The weld part 60A is a part resulted after a region of the shaft part 32 inserted in the through hole 51a and protruding into the pressure chamber 12 and a region surrounding the through hole 51a of the base part 51 are welded by a welding material that is a resin material. The base part 51 of the diaphragm 50 and the outer circumferential face of the shaft part 32 of the opening/closing mechanism 30 are connected via the weld part 60A.

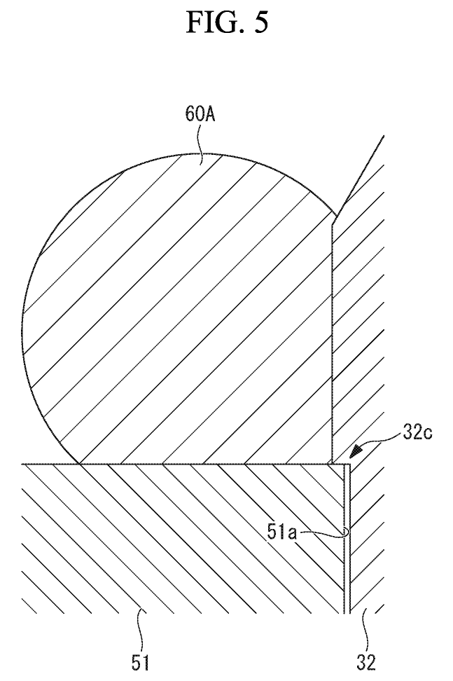

FIG. 5 is a partial enlarged view of a part near the weld part 60A illustrated in FIG. 4. As illustrated in FIG. 5, the step part 32c having an outer diameter increasing toward a distal end and arranged at an end of the through hole 51a in a state where the shaft part 32 is protruded into the pressure chamber 12 is formed to the shaft part 32.

According to the flow rate adjusting device 100A of the present embodiment, the shaft part 32 having the step part 32c formed thereto is driven into the through hole 51a formed in the base part 51 of the diaphragm 50, and thereby a state where the elastically deformed step part 32c is arranged at the end of the through hole 51a can be obtained. Since the step part 32c is engaged with the end of the through hole 51a and thereby the shaft part 32 is positioned with respect to the base part 51 of the diaphragm 50, operation to form the weld part 60A can be easily performed by using a welding material.

### Other Embodiments

Although the flow rate adjusting device 100A of the second embodiment is of a form in which, in a state where the base part 51 and the shaft part 32 are connected by the weld part 60A, the seal protrusion 51b comes into contact with the seal groove 32b, and the seal region extending about the axis X is formed, other forms may be employed. For example, a modified example in which the base part 51 does not have the seal protrusion 51b and the shaft part 32 does not have the seal groove 32b may be employed. According to this modified example, although no seal region is formed by the seal groove 32b and the seal protrusion 51b, introduction of a liquid to the pressure chamber 12 can be prevented by the weld part 60A.

Further, although the flow rate adjusting device 100A of the second embodiment is of a form in which the shaft part 32 has the step part 32c, other forms may be employed. For example, a modified example in which the shaft part 32 does not have the step part 32c may be employed. According to this modified example, although the shaft part 32 is not positioned with respect to the base part 51 of the diaphragm 50 by the step part 32c, the operator is able to perform operation to form the weld part 60A using the welding material by suitably holding a state where the shaft part 32 is inserted in the through hole 51a.

What is claimed is:

1. A flow rate adjusting device comprising:
a first housing having a pressure chamber formed inside the first housing, wherein an operating gas is externally introduced into the pressure chamber;
a second housing having a valve chamber, an upstream channel, and a downstream channel that are formed inside the second housing, the upstream channel allowing the valve chamber and an inlet port to communicate with each other, and the downstream channel allowing the valve chamber and an outlet port to communicate with each other;
an opening/closing mechanism configured to come into contact with or move away from a valve seat provided on an inner circumferential face of the valve chamber to establish a closed state where the upstream channel and the downstream channel are blocked from each other or an open state where the upstream channel and the downstream channel are in communication with each other;
a biasing force generating unit configured to generate a biasing force that moves the opening/closing mechanism in a direction of coming into contact with the valve seat;
a first diaphragm connected to the opening/closing mechanism to move along an axis and arranged between the first housing and the second housing so as to partition the pressure chamber and the valve chamber from each other; and
a connection part configured to connect the opening/closing mechanism and the first diaphragm to each other,
wherein the opening/closing mechanism has
a valve body accommodated in the valve chamber and configured to come into contact with or move away from the valve seat, and
a shaft part connected to the valve body and axially formed extending along the axis,
wherein the first diaphragm has
a base part formed circularly about the axis and having a through hole at the center of the base part, and
a first thin-film part formed annularly about the axis so as to be connected to an outer circumferential edge of the base part and having a smaller thickness along the axis than the base part, and
wherein the connection part connects the shaft part to the base part inside the pressure chamber, the shaft part being inserted in the through hole and protruding into the pressure chamber.

2. The flow rate adjusting device according to claim 1,
wherein the valve chamber has a first space being in communication with the upstream channel, the valve body being arranged in the first space, and a second space being in communication with the downstream channel, the shaft part being arranged in the second space,
wherein a valve hole is formed in the second housing, the valve hole allowing the first space and the second space to communicate with each other, and the opening/closing mechanism being inserted in the valve hole,
wherein the opening/closing mechanism has a second thin-film part formed annularly about the axis so as to be connected to an outer circumferential edge of the valve body and has a second diaphragm partitioning the valve chamber and a lower space from each other, the biasing force generating unit being arranged in the lower space,
wherein a second outer diameter of the second thin-film part is smaller than a first outer diameter of the first thin-film part, and
wherein an amount of movement along the axis of the opening/closing mechanism from the open state to the closed state is set to be 10% or less of the second outer diameter.

3. The flow rate adjusting device according to claim 2, wherein the valve body, the shaft part, and the second diaphragm are integrally formed of PFA.

4. The flow rate adjusting device according to claim 1,
wherein a seal protrusion is formed on an end face on the valve chamber side of the base part, the seal protrusion being formed about the axis so as to surround the through hole and protruding to the valve chamber,
wherein a seal groove and an external thread are formed to the shaft part, the seal groove being formed annularly about the axis so as to be engaged with the seal protrusion, and the external thread being formed in a region protruding to the pressure chamber in a state where the shaft part is inserted in the through hole,
wherein the connection part is a member having a fastening hole having an internal thread formed in an inner circumferential face of the fastening hole,
wherein the opening/closing mechanism is connected to the first diaphragm by the internal thread of the connection part being fastened onto the external thread of the shaft part, and
wherein in a state where the opening/closing mechanism and the first diaphragm are connected by the connection part, the seal protrusion comes into contact with the seal groove, and a seal region extending about the axis is formed.

5. The flow rate adjusting device according to claim 1,
wherein the first diaphragm and the opening/closing mechanism are formed of a resin material, and
wherein the connection part is a weld part, wherein a region of the shaft part inserted in the through hole and protruding into the pressure chamber and a region surrounding the through hole of the base part are welded at the weld part by a welding material that is a resin material.

6. The flow rate adjusting device according to claim 5, wherein a step part is formed to the shaft part, the step part having an outer diameter increasing toward a distal end and being arranged at an end of the through hole in a state where the shaft part is protruded into the pressure chamber.

7. The flow rate adjusting device according to claim 5,
wherein a seal groove is formed on an end face on the valve chamber side of the base part so as to surround the through hole,
wherein an annular seal protrusion protruding toward the end face of the base part along the axis so as to be engaged with the seal groove is formed in the shaft part, and
wherein in a state where the opening/closing mechanism and the first diaphragm are connected by the connection part, the seal protrusion comes into contact with the seal groove, and a seal region extending about the axis is formed.
